(19) United States
(12) Patent Application Publication
(10) Pub. No.: US 2013/0143034 A1
(43) Pub. Date: Jun. 6, 2013

(54) Rust-Preventive Coating

(71) Applicants: Yuken Industry Co., Ltd., Kariya-shi (JP); Honda Motor Co., Ltd., Tokyo (JP)

(72) Inventors: Masayuki Iijima, Kariya-shi (JP); Masayuki Tsujimoto, Kariya-shi (JP); Kenji Suto, Wako-shi (JP); Hideaki Takada, Wako-shi (JP)

(73) Assignees: HONDA MOTOR CO., LTD., Tokyo (JP); YUKEN INDUSTRY CO., LTD., Kariya-shi (JP)

(21) Appl. No.: 13/705,557

(22) Filed: Dec. 5, 2012

(30) Foreign Application Priority Data
Dec. 6, 2011 (JP) 2011-267129

(51) Int. Cl. C09D 5/10

(52) U.S. Cl. CPC C09D 5/106
USPC 428/328; 106/14.41

(57) ABSTRACT

A rust-preventive coating comprises a zinc-containing coating obtained by heating a liquid layer comprising a zinc-containing inorganic-based paint that contains: an inorganic binder including an organic silicon compound and an organic titanate compound; and a metal-based powder, wherein the metal-based powder comprises aluminum-based powder and zinc-based powder, and this aluminum-based powder is such that a particle size D50 when a percent passing by weight is 50% in a particle-size accumulation curve is 10 μm or more and 20 μm or less, a leafing value is 70% or more, and a mass ratio to the metal-based powder is 10 mass % or more and 40 mass % or less.

### TECHNICAL FIELD

The present invention relates to a coating with favorable gloss appearance even if being a rust-preventive coating obtained from so-called zinc-rich paint that contains zinc- based powder.

### BACKGROUND ART

In the field of a paint for the purpose of rust prevention such as for a steel member, a rust-preventive paint has widely been used which primarily contains zinc powder and chromic acid. This paint can keep the zinc powder stable for a long time due to the passivation behavior caused by hexavalent chromium, thus providing an excellent storage stability of liquid. In addition, a coating comprised of this paint that contains zinc powder prevents corrosion of an underlying member (substrate) because the well-known sacrificial anticorrosive function of zinc effectively works, and an excellent rust-preventive effect can thereby be obtained.

In recent years, however, manufacturers of consumer products such as automobiles and precision equipments contemplate to proceed to no use of substances that contain hexavalent chromium (referred also to as “hexavalent chromium based substances”, hereinafter). Accordingly, also in the field of rust-preventive paints, there is a strong demand for paints absolutely free from hexavalent chromium based substances.

One example of such rust-preventive paints that contain no hexavalent chromium based substance is a kind of paint in which zinc powder and a binder component are dispersed or dissolved in an organic solvent, i.e. a zinc-rich paint. Such zinc-rich paints are categorized into organic ones and inorganic ones, among which inorganic ones having organic silicon compounds as vehicles are superior in terms of durability thus being used as basecoat agents in heavy-duty anticorrosive painting such as for ships and bridges.

This type of inorganic-based zinc-rich paint for basecoat is used to usually be a thick coating of 100 μm or more, but Patent Document 1 discloses a rust-preventive paint which can fonn a coating having an excellent anticorrosive property even if being a thin coating of about 10 μm. Primary use of such thin coatings having high anticorrosive property is for business equipments, electrical apparatuses, automobiles, etc, and specifically for secondary processed components, such as fasteners including bolts and nuts, attachments including clamps and clips, and press-molded products including plates, housings, hinges and panels. These members are required to have high accuracy in assembling and at the same time high level of strength and adhesiveness of their coatings because they may be subjected to a large shear force when being fabricated and assembled.

### PRIOR ART DOCUMENTS(S)

### Patent Document(s)

[Patent Document 1] Japanese Patent No. 4111531

### SUMMARY OF THE INVENTION

### Problems to be Solved by the Invention

The rust-preventive paint disclosed in Patent Document 1 is a favorable paint in regard to the point that a member having excellent anticorrosive property can be provided even with a thin coating formed of the paint.

In recent years, however, the functionality required for coatings is diversified, and consumers may need products not only with rust-preventive function but with favorable appearances. If a coating has its own favorable appearance, then a color painting process is not required for giving a specific appearance, so that the manufacturing process can be simplified and the coating can be obtained to achieve a thin thickness as the entire coating.

An object of the present invention is, therefore, to provide a coating that satisfies the above need, i.e. a coating that has a rust-preventive function as well as a favorable appearance.

### Means for Solving the Problems

As a result of intensive studies, the present inventors have discovered that the rust-preventive paint disclosed in Patent Document 1 is used as the basis to prepare a rust-preventive paint in which metal-based powder includes aluminum-based powder and zinc-based powder, and the mass ratio of the aluminum-based powder in the metal-based powder is made to be within a predetermined range, thereby to result in successful achievement that the obtained rust-preventive coating can have gloss appearance and the rust-preventive function can be improved compared to metal-based powder that consists of zinc-based powder.

Moreover, it has also been discovered that the rust-preventive paint disclosed in Patent Document 1 is used as the basis to prepare a rust-preventive paint which is used to provide a multi-layer rust-preventive coating, i.e. a rust-preventive coating comprising at least two layers, and the at least two layers are laminated to contact with each other, thereby resulting in successful achievement that the rust-preventive function can sufficiently be ensured even if the mass ratio of aluminum-based powder is increased in metal-based powder within the outer rust-preventive coating layer.

Aspects of the present invention accomplished on the basis of the above discoveries are as follows.

(1) A rust-preventive coating comprising a first zinc-containing coating obtained by heating a liquid layer, the liquid layer comprising a first zinc-containing inorganic-based paint that contains, on the basis of whole paint, an inorganic binder including 5 mass % or more and 40 mass % or less of an organic silicon compound and 0.05 mass % or more and 2 mass % or less of an organic titanate compound; 20 mass % or more and 60 mass % or less of a first metal-based powder; and 10 mass % or more and 60 mass % or less of an organic solvent, wherein the first metal-based powder contained in the first zinc-containing inorganic-based paint comprises: a first aluminum-based powder comprising one or more selected from aluminum powders and aluminum alloy powders; and a first zinc-based powder comprising one or more selected from zinc powders and zinc alloy powders, and the first aluminum-based powder is such that a particle size D50 when a percent passing by weight is 50% in a particle-size accumulation curve is 10 μm or more and 20 μm or less, a leafing value is 70% or more, and a mass ratio to the first metal-based powder is 10 mass % or more and 40 mass % or less.

(2) The rust-preventive coating as set forth in the above (1), wherein the first metal-based powder has a scale form.

(3) The rust-preventive coating as set forth in the above (2), wherein the metal-based powder having the scale form is such that an average thickness of the metal-based powder is 1/200 or more and ½ or less relative to an average thickness of the first zinc-containing coating that contains the metal-based powder, and an average value of longitudinal diameter of the metal-based powder is 10 times or more and 50 times or less relative to the average thickness of the metal-based powder.

(4) The rust-preventive coating as set forth in the above (2), wherein the metal-based powder having the scale form is such that an average value of longitudinal diameter of the metal-based powder is 1.0 μm or more and 50 μm or less, and an average thickness thereof is 0.05 μm or more and 1.0 μm or less.

(5) The rust-preventive coating as set forth in either one of the above (1), wherein the organic silicon compound contained in the first zinc-containing inorganic-based paint comprises one or more compounds selected from a group consisting of tetraalkyl silicate compounds having an alkyl group having 3 or less carbon atoms and oligomers thereof.

(6) The rust-preventive coating as set forth in either one of the above (1), wherein the organic titanate compound contained in the first zinc-containing inorganic-based paint comprises an organic compound represented by a general formula of Ti(X)₄ and an oligomer thereof, where X represents one or more functional groups selected from a group consisting of: alkoxy groups having 4 or less carbon atoms; chelating substituent groups; and hydroxyl group.

(7) A rust-preventive coating comprising a second zinc-containing coating and a third zinc-containing coating provided on a proximate side of the second zinc-containing coating to a substrate, wherein the second zinc-containing coating is obtained by heating a liquid layer, the liquid layer comprising a second zinc-containing inorganic-based paint that contains, on the basis of whole paint, an inorganic binder including 5 mass % or more and 40 mass % or less of an organic silicon compound and 0.05 mass % or more and 2 mass % or less of an organic titanate compound; 20 mass % or more and 60 mass % or less of a second metal-based powder; and 10 mass % or more and 60 mass % or less of an organic solvent, the third zinc-containing coating is obtained by heating a liquid layer, the liquid layer comprising a third zinc-containing inorganic-based paint that contains, on the basis of whole paint, an inorganic binder including 5 mass % or more and 40 mass % or less of an organic silicon compound and 0.05 mass % or more and 2 mass % or less of an organic titanate compound; 20 mass % or more and 60 mass % or less of a third metal-based powder; and 10 mass % or more and 60 mass % or less of an organic solvent, the second metal-based powder contained in the second zinc-containing inorganic-based paint comprises: a second aluminum-based powder comprising one or more selected from aluminum powders and aluminum alloy powders; and a second zinc-based powder comprising one or more selected from zinc powders and zinc alloy powders, the second aluminum-based powder is such that the a particle size D50 when a percent passing by weight is 50% in a particle-size accumulation curve is 10 μm or more and 20 μm or less, a leafing value is 70% or more, and a mass ratio to the second metal-based powder is 10 mass % or more, and the third metal-based powder includes a third zinc-based powder comprising one or more selected from zinc powders and zinc alloy powders.

(8) The rust-preventive coating as set forth in the above (7), wherein the third metal-based powder further contains a third aluminum-based powder comprising one or more selected from aluminum powders and aluminum alloy powders.

(9) The rust-preventive coating as set forth in the above (8), wherein a ratio R2/R3 is larger than one, where R2 represents a mass ratio of the second aluminum-based powder to the second metal-based powder, and R3 represents a mass ratio of the third aluminum-based powder to the third metal-based powder.

(10) The rust-preventive coating as set forth in either one of the above (7), wherein at least one of the second metal-based powder and the third metal-based powder has a scale form.

(11) The rust-preventive coating as set forth in the above (10), wherein the metal-based powder having the scale form is such that an average thickness of the metal-based powder is 1/200 or more and ½ or less relative to an average thickness of the second zinc-containing coating and/or the third zinc-containing coating that contain the metal-based powder, and an average value of longitudinal diameter of the metal-based powder is 10 times or more and 50 times or less relative to the average thickness of the metal-based powder.

(12) The rust-preventive coating as set forth in the above (10), wherein the metal-based powder having the scale form is such that an average value of longitudinal diameter of the metal-based powder is 1.0 μm or more and 50 μm or less, and an average thickness thereof is 0.05 μm or more and 1.0 μm or less.

(13) The rust-preventive coating as set forth in either one of the above (7) to (12), wherein at least one of the organic silicon compound contained in the second zinc-containing inorganic-based paint and the organic silicon compound contained in the third zinc-containing inorganic-based paint comprises one or more compounds selected from a group consisting of tetraalkyl silicate compounds having an alkyl group having 3 or less carbon atoms and oligomers thereof.

(14) The rust-preventive coating as set forth in either one of the above (7), wherein at least one of the organic titanate compound contained in the second zinc-containing inorganic-based paint and the organic titanate compound contained in the third zinc-containing inorganic-based paint comprises an organic compound represented by a general formula of Ti(X)₄ and an oligomer thereof, where X represents one or more functional groups selected from a group consisting of: alkoxy groups having 4 or less carbon atoms; chelating substituent groups; and hydroxyl group.

(15) A rust-preventive member comprising the rust preventive coating as set forth in either one of the above (1) to (14) on a substrate, wherein a gloss value Gs(60°) at an incident angle of 60° measured in compliance with JIS Z8741 is 7% or more for a surface of the rust-preventive coating.

(16) The rust-preventive member as set forth in the above (15), further comprising an overcoat layer provided at outside the rust-preventive coating.

### ADVANTAGEOUS EFFECT OF THE INVENTION

The rust-preventive coating according to the present invention has an excellent anticorrosive property even if being a thin coating of about 10 μm and also has a bright and gloss appearance in itself.

### EMBODIMENTS FOR CARRYING OUT THE INVENTION

### 1. First Embodiment

A rust-preventive coating according to a first embodiment of the present invention comprises a first zinc-containing coating. This first zinc-containing coating is to be produced from a nonaqueous first zinc-containing inorganic-based paint as will then be described.

### (1) First Zinc-Containing Inorganic-Based Paint

The first zinc-containing inorganic-based paint according to the present embodiment is comprised of a nonaqueous liquid-form composition that contains: an inorganic binder including 5 mass % or more and 40 mass % or less of an organic silicon compound and 0.05 mass % or more and 2 mass % or less of an organic titanate compound; 20 mass % or more and 60 mass % or less of a first metal-based powder; and 10 mass % or more and 60 mass % or less of an organic solvent. Unless otherwise stated hereinafter, “%” for the contained amount of a paint component means the percentage by mass based on the whole paint.

### i) Organic Silicon Compound

The first zinc-containing inorganic-based paint according to the present embodiment contains an organic silicon compound as one of components that constitute the inorganic binder. The organic silicon compound is a primary constituent of the inorganic binder.

The organic silicon compound comprises one or more selected from alkoxysilanes and hydrolysates thereof. The alkoxy silane is preferred to be a compound represented by a general formula of (X′)Si(X″)₃.

X′ herein is selected from: hydroxyl group; lower alkoxy groups such as methoxy, ethoxy and isopropoxy; lower alkyl groups such as methyl and ethyl; lower alkenyl groups such as vinyl; and lower alkyl groups that contain functional groups, such as γ-glycidoxypropyl, γ-metacryloxypropyl and γ-mercaptopropyl. Each X″ is selected from hydroxyl group and alkoxy groups such as methoxy, ethoxy and isopropoxy, and the three X″s may be identical or different.

Specific examples of the alkoxysilane include, but not limited to, tetramethoxysilane, tetraethoxysilane, methyltrimethoxysilane, methyltriethoxysilane, vinyltrimethoxysilane, vinyltriethoxysilane and γ-glycidoxypropyltrimethoxysilane. Various kinds of alkoxysilane commercially available as silane coupling agents may also be used.

Among these examples of the alkoxysilane, preferred is a tetraalkoxysilane such as tetramethoxysilane, tetraethoxysilane and tetrapropoxysilane or an oligomer thereof, and particularly preferred is a tetraalkoxysilane having 3 or less carbon atoms or an oligomer thereof. When a condensation reaction occurs during a baking process, a coating can be formed to have a three-dimensional cross-linked structure thereby easily improving the coating strength. In addition, cracks are unlikely to grow because the volume contraction is relatively small during the condensation.

It is preferred that the amount of the above organic silicon compound is 5% or more and 40% or less relative to the whole paint. If the amount is less than 5%, then the coating strength tends to decrease. If the added amount is further less, then obvious voids occur among metal-based powder to deteriorate the rust-preventive function. If, on the other hand, an excessive amount is added over 40%, then the rust-preventive function tends to deteriorate because the contained amount of the first metal-based powder is relatively reduced in the first zinc-containing coating. In addition, the function of suppressing cracks from progressing may possibly be deteriorated because the overlapping areas of particles of the first metal-based powder to be laminated become small. Particularly preferred range is 10% or more and 35% or less.

### ii) Organic Titanate Compound

The first zinc-containing inorganic-based paint according to the present embodiment contains an organic titanate compound as one of components that constitute the inorganic binder. Containing the organic titanate compound prevents cracks from occurring in the first zinc-containing coating obtained by performing a baking process at a high temperature.

The organic titanate compound means an organic compound represented by a general formula of Ti(X)₄ and an oligomer thereof. Each X herein is selected from hydroxyl group, lower alkoxy groups and chelating substituent groups, and the four Xs may be identical or different.

The lower alkoxy group means an alkoxy group having 6 or less carbon atoms, preferably 4 or less carbon atoms, such as methoxy, ethoxy, propoxy, isopropoxy, butoxy, isobutoxy, and tert-butoxy.

The chelating substituent group means a group derived from an organic compound having a chelate forming ability. Examples of such an organic compound include: a β-diketone such as acetylacetone; an alkylcarbonylcabonic acid such as acetoacetic acid and ester thereof; a hydroxy acid such as lactic acid; and an alkanolamine such as triethanolamine. Specific examples of the chelating substituent group include lactate, ammoniumlactate, triethanolaminate, acetylacetonate, acetoacetate, and ethylacetoacetate.

This organic titanate compound exhibits a high functionality when added with a small amount as will be described later. That is, when subjected to a baking process at a high temperature, the added organic titanate compound acts as a curing agent or a catalyst to facilitate a three-dimensional cross-linking reaction of the organic silicon compound. Consequently, the curing rate of the binder component increases to thereby suppress cracks from progressing.

Moreover, the presence of this organic titanate compound also facilitates the chemical bond between the organic silicon compound and the first metal-based powder and the chemical bond between the organic silicon compound and a substrate (such as a steel material), thus enhancing the bonding strengths. This allows for preventing interfacial delamination between the first metal-based powder and the binder and between the substrate and the binder thereby to suppress cracks from progressing.

It is preferred that the adding amount of the organic titanate compound is 0.05% or more and 2.0% or less. If the amount of the organic titanate compound is unduly small, then the effect thereof cannot be obtained and large cracks are likely to occur in the coating, thus resulting in a possibility that the rust-preventive property of the first zinc-containing coating will deteriorate. In view of stably suppressing the occurrence of cracks which negatively affect the rust-preventive property, it is more preferred that the adding amount of the organic titanate compound is 0.10% or more. If, on the other hand, the adding amount of the organic titanate compound is unduly large, then the coating is likely to absorb ambient moisture thereby to be hydrolyzed, thus having a tendency of reduced pot life. In view of stably suppressing the pot life from being reduced to such an extent that negatively affects the productivity, it is more preferred that the adding amount of the organic titanate compound is 0.15% or less.

iii) First Metal-Based Powder

The first zinc-containing inorganic-based paint according to the present embodiment contains a first metal-based powder. The first metal-based powder imparts an anticorrosive property to the first zinc-containing coating as well as provides a metallic appearance. The first metal-based powder comprises: a first aluminum-based powder comprising one or more selected from aluminum powders and aluminum alloy powders; and a first zinc-based powder comprising one or more selected from zinc powders and zinc alloy powders. Examples of aluminum alloy include Al—Cu, Al—Mn, Al—Si, Al—Mg, Al—Mg—Si and Al—Zn based alloys. Examples of zinc alloy include Zn—Ni, Zn—Sn, Zn—Fe, Zn—Al and Zn—Al—Mg.

The first aluminum-based powder according to the present embodiment is such that a particle size D50 when a percent passing by weight is 50% in a particle-size accumulation curve defined by JIS A1204 (referred simply to as “D50 particle size” hereinafter) is 10 μm or more and 20 μm or less. If the D50 particle size is less than 10 μm, then the first zinc-containing coating is specifically difficult to obtain desired gloss even when the first aluminum-based powder is contained. In view of stably obtaining desired gloss, the D50 particle size is preferably 12 μm or more, and further preferably 14 μm or more. If, on the other hand, the D50 particle size exceeds 20 μm, then there is a concern that the first aluminum-based powder easily drops off from the first zinc-containing coating thereby to deteriorate the anticorrosive property. In view of stably avoiding such concerns from occurring, the D50 particle size is preferably 18 μm or less, and further preferably 16 μm or less.

The first aluminum-based powder according to the present embodiment is such that a leafing value defined by JIS K5906 is 70% or more. If the above leafing value is less than 70%, then the first zinc-containing coating is unlikely to increase its gloss even when the first aluminum-based powder is contained. In view of stably obtaining an act that the gloss of the first zinc-containing coating is enhanced on the basis of the first aluminum-based powder being contained, the above leafing value is preferred to be 75% or more.

The first aluminum-based powder according to the present embodiment is such that the mass ratio thereof to the first metal-based powder is 10 mass % or more and 40 mass % or less. If the above mass ratio is less than 10 mass %, then it is difficult to obtain an advantageous effect such that the gloss of the first zinc-containing coating is enhanced on the basis of the contained first aluminum-based powder. In view of stably obtaining the above advantageous effect, the mass ratio of the first aluminum-based powder to the first metal-based powder is preferably 15 mass % or more, and further preferably 20 mass % or more. If, on the other hand, the above mass ratio exceeds 40 mass %, then the anticorrosive property of the first zinc-containing coating may possibly be deteriorated because the contained amount of the first zinc-based powder is relatively reduced. In view of stably suppressing the anticorrosive property of the first zinc-containing coating from being deteriorated, the mass ratio of the first aluminum-based powder to the first metal-based powder is preferably 35 mass % or less, and further preferably 30 mass % or less.

Since the mass ratio of the first aluminum-based powder to the first metal-based powder is as the above according to the present embodiment, the mass ratio of the first zinc-based powder to the first metal-based powder is 60 mass % or more and 90 mass % or less according to the present embodiment.

The first metal-based powder as a paint raw material preferably has a scale form in order for the coating to have a high anticorrosive property even with reduced thickness of the first zinc-containing coating. Being in such a scale form allows a structure to be achieved in which particles of the first metal-based powder are laminated along the thickness direction in the first zinc-containing coating, and more specifically particles of the first metal-based powder are laminated so that the longest axes thereof are directed in the in-plane direction of the surface of the substrate. This laminated structure results in an advantageous effect that, even if cracks are generated in the first zinc-containing coating due to contraction caused by polymerization of the binder component, those cracks are suppressed from progressing, and such large cracks that expose the substrate are prevented from occurring.

When the first metal-based powder has a scale form, it is preferred that an average thickness of the first metal-based powder (i.e. an average thickness of particles thereof) is 1/200 or more and ½ or less relative to an average thickness of the first zinc-containing coating, and an average value of longitudinal diameter (length of the maximum length portion of the scale form) of the first metal-based powder is 10 times or more and 50 times or less relative to the average thickness of the first metal-based powder. For example, if the thickness of the first zinc-containing coating is about 10 μm, then it is preferred that the average thickness of the first metal-based powder particles having the scale form is 0.05 μm or more and 5 μm or less, and the average value of longitudinal diameter thereof is 0.5 μm or more and 100 μm or less.

Moreover, even in a condition where variations occur in the thickness of the first zinc-containing coating depending on the coating condition for the first zinc-containing inorganic-based paint, if the average value of longitudinal diameter of the first metal-based powder is 1.0 μm or more and 50 μm or less, particularly preferably 4.0 μm or more and 20 μm or less, and the average thickness of the scale form is 0.05 μm or more and 1.0 μm or less, particularly preferably 0.05 μm or more and 0.5 μm or less, then cracks are unlikely to occur even during a baking process, and the first zinc-containing coating can be obtained to have a significantly excellent rust-preventive property.

Note that, if the average value of longitudinal diameter is excessively smaller than the above ranges, then the structure cannot easily be obtained in which the metal-based powder particles having the scale form are laminated in the first zinc-containing coating, and the suppressing effect for the crack progressing tends to be reduced. If, on the other hand, the average value of longitudinal diameter is excessively larger than the above ranges, then the distribution of the first metal-based powder will be coarse, and the rust-preventive property may possibly be negatively affected.

Note also that, if the average thickness of the scale form in the first metal-based powder is smaller than the above ranges, then the scale form may easily be destroyed during the stirring/kneading operation for the paint and become difficult to be formed, and the laminated structure will thus be unlikely to be obtained. If, on the other hand, the average thickness of the scale form is larger than the above ranges, then the structure cannot easily be obtained in which plural metal-based powder particles are laminated along the thickness direction of the coating, and the suppressing effect for the crack progressing may be reduced.

The composition ratio of the first metal-based powder in the first zinc-containing inorganic-based paint is preferably within a range of 20% or more and 60% or less as a percentage by mass relative to the whole paint, and more preferably 30% or more and 50% or less. If this ratio is unduly high, then the first zinc-containing inorganic-based paint is difficult to be coated in a form of thin coating, and the strength of obtained first zinc-containing coating decreases. If, however, this ratio is unduly low, then cracks are likely to progress thereby resulting in problems such as the deterioration in rust-preventive property of the coating.

### iv) Organic Solvent

The first zinc-containing inorganic-based paint according to the present embodiment contains organic solvent thereby being wettable to a member to be painted during the coating operation, and a coating having high adhesive property can be achieved. In addition, containing the organic solvent allows wide variety of additive agents to be utilized when they are added to make the paint.

Preferable examples of the organic solvent include: alcohols such as methanol, ethanol, propanol, isopropanol, butanol, hexanol, methoxybutanol and methoxymethylbutanol; esters of these alcohols such as acetic acid ester and propionic acid ester; glycols such as ethylene glycol, diethylene glycol, triethylene glycol, polyethylene glycol, propylene glycol, dipropylene glycol and tripropylene glycol; and ethers of these glycols such as monomethyl ether, monoethyl ether and monobutyl ether. In addition, hydrocarbons may also be used, such as toluene, xylene, mineral spirit and solvent naphtha. These may be used alone or as a mixture of two or more thereof.

The contained amount of the organic solvent in the first zinc-containing inorganic-based paint is 10% or more and 60% or less according to the present embodiment. If the contained amount of the organic solvent is less than 10%, then the thickness of a liquid layer obtained by coating the first zinc-containing inorganic-based paint on a substrate is difficult to be reduced to within a desirable range, and/or the thickness of the first zinc-containing coating, which is obtained by baking the substrate provided thereon with the liquid layer, is difficult to be reduced to within a desirable range. In addition, the thickness of the liquid layer may not be even, so that variations may occur in thickness of the obtained first zinc-containing coating. In view of stably suppressing the occurrence of such troubles in regard to the thickness of the first zinc-containing coating, the contained amount of the organic solvent is preferably 15% or more, and further preferably 20% or more. If, on the other hand, the contained amount of the organic solvent exceeds 60%, then, in contrast, there is a concern that the thickness of the first zinc-containing coating is difficult to be increased to within a desirable range. In addition, there is also a concern that the desirable structure in the first zinc-containing coating according to the present embodiment is difficult to be formed, in which the first metal-based powder has a scale form and is located to have regions where particles of the first metal-based powder are laminated in the first zinc-containing coating. In view of stably suppressing such concerns from occurring, the contained amount of the organic solvent is preferably 45% or less, and further preferably 30% or less.

### v) Other Components

The first zinc-containing inorganic-based paint according to the present embodiment may contain, if needed, any of various additive agents used for paints in general. Examples of such additive agents include metal-based compounds, resins, lubricant agents, antifoam agents, coloring pigments, rust-preventive pigments, thickening agents and colloidal silica fine particles.

Examples of metal-based components include oxides, and specifically oxides of magnesium, cobalt, zirconium, nickel, vanadium and molybdenum.

Examples of resins include phenol resin, epoxy resin, acrylic resin, acrylic styrene resin, urethane resin, alkyd resin and melamine resin. Note that the first zinc-containing inorganic-based paint according to the present embodiment is an inorganic paint, and therefore, the contained amount of the organic binder comprised of such resins is less than the contained amount of an inorganic binder. That is, the mass ratio of the contained amount of the inorganic binder and the contained amount of the organic binder is more than one, preferably 10 or more, and further preferably 20 or more, as the ratio (inorganic/organic).

Examples of lubricant agents include oxidized polyethylene, oxidized polyolefin, graphite and molybdenum disulfide.

Examples of antifoam agents include silicon-based antifoam agents and non-silicon-based antifoam agents, and surfacants may also be used.

Examples of coloring pigments include inorganic pigments such as iron oxide and ultramarine blue, and organic pigments such as azo pigments and polycyclic pigments.

Examples of rust-preventive pigments include zinc phosphate, magnesium phosphate, zinc molybdate, aluminum phosphomolybdate and other pigments.

Examples of thickening agents include organic thickening agents such as fatty acid amides, polyamides, oxidized polyethylene and hydroxylpropyl cellulose, and inorganic thickening agents such as silicate salt based compounds.

The colloidal silica fine particles are fine sol silica particles having a particle size of 1 μm or less and have an advantageous effect of improving the anticorrosive property and the coating strength, like the above-described silicon compound. Examples of the colloidal silica fine particles includes organosilica sol in which colloidal silica is dispersed in an organic solvent (e.g. SNOWTEX available from Nissan Chemical Industries, Ltd.), and fumed silica (gaseous phase silica).

In addition, commonly used additive agents for paints may also be contained in the first zinc-containing inorganic-based paint according to the present embodiment, such as wetting agents, dispersing agents, surface conditioning agents and rheology controlling material.

These additional additive agents are preferably added with a total amount of 0.1% or more and 10% or less relative to the whole paint. If the amount is less than 0.1%, then the additive agents may not effectively work, while on the other hand, if the amount is more than 10%, then the composition ratio of the first metal-based powder and the binder component as main agents is relatively decreased, and the rust-preventive coating with favorable gloss and excellent anticorrosive property may be difficult to be obtained.

Aforementioned each component that constitutes the first zinc-containing inorganic-based paint according to the present embodiment may comprise one or more types.

Note that the first zinc-containing inorganic-based paint according to the present embodiment is preferred to be substantially free from hexavalent chromium based substances.

### vi) Manufacturing Method for the First Zinc-Containing Inorganic-Based Paint

Manufacturing method for the first zinc-containing inorganic-based paint according to the present embodiment is not particularly limited. For example, the first zinc-containing inorganic-based paint may be prepared by sufficiently stirring/mixing the above-described components to uniformly disperse the first metal-based powder into the liquid.

### (2) First Zinc-Containing Coating

The first zinc-containing coating according to the present embodiment can be obtained by heating a liquid layer that comprises the above first zinc-containing inorganic-based paint.

Although the thickness of the first zinc-containing coating is not particularly limited, a typical process may preferably be performed such that the thickness is within a range of 2 μm to 30 μm. If the thickness of the first zinc-containing coating is less than 2 then the first zinc-containing coating may have a structure where only a part of the first metal-based powder is fixed by the binder, in which case problems may occur such as that the first metal-base powder drops off to deteriorate the anticorrosive property, and desired gloss cannot be obtained. In order to stably avoid such problems that deterioration in anticorrosive property and gloss becomes significant, the first zinc-containing coating is preferred to have a thickness of 4 μm or more. If, on the other hand, the thickness of the first zinc-containing coating exceeds 30 μm, then the contraction amount especially increases from the liquid layer to the first zinc-containing coating, and the possibility that cracks occur to negatively affect the anticorrosive property may even be increased depending on the composition of the first zinc-containing inorganic-based paint. In addition, the first zinc-containing coating being thick leads to increase in cost for manufacturing the coating. In view of stably suppressing the possibility of the above occurrence of cracks, the first zinc-containing coating preferably has a thickness of 20 μm or less, and more preferably 15 μm or less.

The thickness of the liquid layer comprising the first zinc-containing inorganic- based paint, which provides the first zinc-containing coating according to the present embodiment, may be set in consideration of the composition of the first zinc-containing inorganic-based paint so that the thickness of the first zinc-containing coating obtained by heating the first zinc-containing inorganic-based paint will be within a desired range.

A method for forming the liquid layer is not particularly limited, and any known coating method may appropriately be employed with consideration for the material and shape of a substrate. Specific examples of the coating method include roll-coating, spraying, brush painting and dipping.

Heating treatment (baking process) for the above liquid layer may be performed by heating the liquid layer at a temperature of 200° C. to 400° C. during 10 minutes or more and 120 minutes or less. This baking process causes the organic silicon compound to be subjected to a condensation reaction associated with the organic titanate compound as a curing agent or a catalyst, and the surface of a substrate is formed thereon with the first zinc-containing coating, which is a coating that contains the first metal-based powder. If the heating temperature is unduly low, then specifically long time is required for the above condensation reaction to be completed, and the obtained first zinc-containing coating may deteriorate its anticorrosive property because the above condensation reaction would not have been completed in the coating. In view of reducing the amount of time required for the above condensation reaction to enhance the productivity, the heating temperature is preferably 230° C. or higher, and more preferably 250° C. or higher. If, on the other hand, the heating temperature is unduly high, then the liquid layer is difficult to be uniformly heated, and the anticorrosive property of the obtained first zinc-containing coating may possibly be deteriorated. In addition, some substrates may have problems such as deformation and oxidation if the heating temperature is unduly high. Therefore, the upper limit of the heating temperature is preferably about 400° C., and more preferably 300° C. or lower.

Prior to the above baking process, a preheating may be performed to heat the above liquid layer at a temperature of 200° C. or lower so that the organic solvent contained in the liquid layer is preferentially evaporated.

A step involving the forming of the above liquid layer and the baking thereof may be iteratively performed. In the second round of the step and subsequent steps, the above liquid layer is to be formed on the first zinc-containing coating. A rust-preventive coating obtained by depositing a plurality of first zinc-containing coatings in this manner also falls within the rust-preventive coating according to the present embodiment. Note that, when such a rust-preventive coating is formed by depositing a plurality of first zinc-containing coatings, the composition of paint for providing individual first zinc-containing coating may not necessarily be absolutely identical, but the mass ratio R1 of the first aluminum-based powder to the first metal-based powder is made to be substantially identical. If the above mass ratio R1 is different from one another in the plurality of first zinc-containing coating included in the rust-preventive coating, then the rust-preventive coating may not be said as being a rust-preventive coating according to the present embodiment, thus being categorized as a rust-preventive coating according to a second embodiment as will be described later.

### (3) Substrate

Although types of a substrate to be formed thereon with the first zinc-containing coating according to the present embodiment are not particularly limited, the substrate is preferred to be formed of a material such that dimensions of the substrate may not considerably change due to the above baking process and oxidation may not be significant within regions other than the region where the first zinc-containing coating is formed.

A material typically used for the substrate according to the present embodiment is a steel material, and other examples thereof include copper-based materials and nickel-based materials. The surface of the steel material may preliminarily be coated by a metal such as zinc. Typical example of a method for performing such a coating is plating. Alternatively or additionally, physical process such as shotblasting process may be performed and/or chemical process may be performed, such as chemical conversion process (e.g. phosphate coating process for a material of steel).

The shape of the substrate according to the present embodiment may be freely selected, and the substrate may be represented by primary processed products such as plate materials, rod materials and pipe materials, or secondary processed products such as bolts, nuts, hinges, engine blocks, gaskets and housings. Examples of processes for such secondary processed products include cutting/grinding, press working, bending work, cutting process, casting process, forging process and other processes.

### (4) Rust-Preventive Member

The rust-preventive member according to the present embodiment comprises a rust-preventive coating on the above substrate, and the rust-preventive coating comprises the above first zinc-containing coating. Comprising this rust-preventive coating allows the rust-preventive member to have an excellent anticorrosive property and high gloss.

In regard to this gloss, it is preferred that a gloss value Gs(60°) at an incident angle of 60° measured in compliance with JIS Z8741 is 7% or more for a surface of the rust-preventive coating. Given such an extent of gloss, the rust-preventive member can be obtained which has favorable appearance from the view point of design without performing a particular appearance adjustment process (typically lamination of colored coating or coatings). In particular, if higher gloss is required, the above gloss value Gs(60°) may be 10% or more, and further preferably 15% or more.

In addition, the rust-preventive member according to the present embodiment may further comprise an overcoat on the rust-preventive coating configured of the first zinc-containing coating. The overcoat layer can be formed using a method and coating liquid known in the art. The overcoat layer is preferred to be a transparent one, i.e. a clear coat layer, so as not to diminish the color tone of the underlying rust-preventive coating having gloss. Specifically, types of the overcoat layer are categorized into inorganic ones, such as using metallic oxides including colloidal silica (silicic acid sol) and titania sol (or precursor substances thereof) or phosphoric salts, and organic ones comprised of thin resin coatings (e.g. polyester, acrylic resin, epoxy resin, phenol resin, polyurethane, melamine resin, fluorine resin and other resins), wherein any type may be used. The thickness thereof may commonly be, such as, but not limited to, within a range of about 0.1 μm to about 30 μm. In general, the overcoat layer is formed by coating and drying the treatment liquid, and the coating may be performed depending on the shape of the substrate by appropriate means such as dipping, spraying and roll-coating. The drying may commonly be drying by heating.

### 2. Second Embodiment

The rust-preventive coating according to a second embodiment of the present invention comprises a second zinc-containing coating and a third zinc-containing coating provided on the proximate side of the second zinc-containing coating to a substrate. That is, if the rust-preventive coating is comprised of the second zinc-containing coating and the third zinc-containing coating, then the rust-preventive member, which comprises rust-preventive coatings, has a configuration in which the third rust-preventive coating is provided on the substrate and the second rust-preventive coating is further provided thereon. This second rust-preventive coating is produced from a nonaqueous second zinc-containing inorganic-based paint, and the third rust-preventive coating is formed from a nonaqueous third zinc-containing inorganic-based paint.

### (1) Second Zinc-Containing Inorganic-Based Paint

The second zinc-containing inorganic-based paint according to the present embodiment contains, on the basis of the whole paint, an inorganic binder including 5 mass % or more and 40 mass % or less of an organic silicon compound and 0.05 mass % or more and 2 mass % or less of an organic titanate compound; 20 mass % or more and 60 mass % or less of a second metal-based powder; and 10 mass % or more and 60 mass % or less of an organic solvent.

Details of the organic silicon compound and the organic titanate compound both contained in the inorganic binder are the same as those contained in the first zinc-containing inorganic-based paint according to the first embodiment, and therefore omitted to be described.

In addition, details regarding the organic solvent and other components and the manufacturing method for the paint are also the same as those in the first embodiment, and therefore omitted to be described.

The second zinc-containing inorganic-based paint according to the present embodiment contains a second metal-based powder. This second metal-based powder, like the first metal-based powder contained in the first zinc-containing inorganic-based paint according to the first embodiment, comprises: a second aluminum-based powder comprising one or more selected from aluminum powders and aluminum alloy powders; and a second zinc-based powder comprising one or more selected from zinc powders and zinc alloy powders. Among properties associated with the second metal-based powder, the range of the D50 particle size, the range of the leafing value and features in shape are in common with the first metal-based powder, but there is a difference that the mass ratio of the second aluminum-based powder to the second metal-based powder is not limited, particularly in its upper limit.

The first zinc-containing coating according to the first embodiment has an upper limit of 40 mass % or less for the mass ratio of the first aluminum-based powder to the first metal-based powder in order for the coating to solely satisfy both of excellent anticorrosive property and gloss.

In contrast, the rust-preventive coating according to the present embodiment has the third zinc-containing coating, as will be described later, between the second zinc-containing coating and the substrate. If this third zinc-containing coating is primarily responsible for the anticorrosive property of the rust-preventive coating, then the anticorrosive property required for the second zinc-containing coating may be eased compared to the anticorrosive property required for the first zinc-containing coating according to the first embodiment. Therefore, the upper limit needs not to be provided for the mass ratio of the second aluminum-based powder contained in the second zinc-containing coating to the second metal-based powder. Of course, the mass ratio of the second aluminum-based powder to the second metal-based powder is not to be 100 mass % because the second metal-based powder in the second zinc-containing coating contains a certain amount of the second zinc-based powder. In this sense, the upper limit of the above mass ratio is less than 100 mass %.

Thus, the mass ratio of the second aluminum-based powder to the second metal-based powder is not limited, particularly in its upper limit, but in view of mitigating the responsibility required for the third zinc-containing coating to ensure the anticorrosive property, the mass ratio of the second aluminum-based powder to the second metal-based powder is preferably 80 mass % or less, and more preferably 40 mass % or less.

### (2) Third Zinc-Containing Inorganic-Based Paint

The third zinc-containing inorganic-based paint according to the present embodiment contains, on the basis of the whole paint, an inorganic binder including 5 mass % or more and 40 mass % or less of an organic silicon compound and 0.05 mass % or more and 2 mass % or less of an organic titanate compound; 20 mass % or more and 60 mass % or less of a third metal-based powder; and 10 mass % or more and 60 mass % or less of an organic solvent.

Details of the organic silicon compound and the organic titanate compound both contained in the inorganic binder are the same as those contained in the first zinc-containing inorganic-based paint according to the first embodiment, and therefore omitted to be described.

In addition, details regarding the organic solvent and other components and the manufacturing method for the paint are also the same as those in the first embodiment, and therefore omitted to be described.

The third zinc-containing inorganic-based paint according to the present embodiment contains a third metal-based powder. This third metal-based powder includes a third zinc-based powder comprising one or more selected from zinc powders and zinc alloy powders. Details of the zinc powders and the zinc alloy powders are the same as the case of the first zinc-based powder according to the first embodiment.

As previously described, the third zinc-containing coating according to the present embodiment is provided thereon with the second zinc-containing coating. Accordingly, the third zinc-containing coating according to the present embodiment is not visible to user in a normal use condition. Therefore, the third zinc-containing coating according to the present embodiment needs not to have certain gloss. Thus, the third metal-based powder in the third zinc-containing coating according to the present embodiment may be sufficient if containing the third zinc-based powder so as to achieve a sacrificial anticorrosive function.

According to one preferred example of the present embodiment, the third metal-based powder also includes a third aluminum-based powder comprising one or more selected from aluminum powders and aluminum alloy powders. Although the reason is not known exactly, rather than the third metal-based powder consisting only of zinc-based material, i.e. the third zinc-based powder, the third metal-based powder containing the third aluminum-based powder sometimes improves the anticorrosive property of the rust-preventive coating comprised of the second zinc-containing coating and the third zinc-containing coating.

Moreover, in further preferred example of the present embodiment where the third metal-based powder also includes the third aluminum-based powder as described above, in which case if a ratio R2/R3 is larger than one, where R2 represents a mass ratio of the second aluminum-based powder to the second metal-based powder and R3 represents a mass ratio of the third aluminum-based powder to the third metal-based powder, then the rust-preventive coating comprised of the second zinc-containing coating and the third zinc-containing coating is to have particularly excellent anticorrosive property.

### (3) Rust-Preventive Coating

The rust-preventive coating according to the present embodiment comprises the second zinc-containing coating and the third zinc-containing coating provided on the proximate side of the second zinc-containing coating to the substrate, and these coatings are to be obtained by respectively heating a liquid layer comprised of the above second zinc-containing inorganic-based paint and a liquid layer comprised of the above third zinc-containing inorganic-based paint.

Although the thickness of the rust-preventive coating according to the present embodiment is not particularly limited, the thickness is preferably set to be within a range of 3 μm to 50 μm. If the thickness of the rust-preventive coating according to the present embodiment is less than 3 μm, then it may be difficult to obtain the structure that comprises the second zinc-containing coating and the third zinc-containing coating. In this case, problems may occur such as that the anticorrosive property deteriorates and desired gloss cannot be obtained. In order to stably avoid such problems that deterioration in anticorrosive property and gloss becomes significant, the rust-preventive coating according to the present embodiment preferably has a thickness of 5 μm or more, and further preferably 10 μm or more. If, on the other hand, the thickness of the rust-preventive coating according to the present embodiment exceeds 50 μm, then the contraction amount especially increases in the course of forming the second zinc-containing coating from the liquid layer comprised of the second zinc-containing inorganic-based paint and also in the course of forming the third zinc-containing coating from the liquid layer comprised of the third zinc-containing inorganic-based paint, and the possibility that cracks occur to negatively affect the anticorrosive property may even be increased depending on the compositions of these zinc-containing inorganic-based paints. In addition, the rust-preventive coating being thick leads to increase in cost for manufacturing the coating. In view of stably suppressing the possibility of the above occurrence of cracks, the rust-preventive coating according to the present embodiment preferably has a thickness of 30 μm or less, and more preferably 25 μm or less.

Each thickness of the second zinc-containing coating and the third zinc-containing coating is preferably, but not limited to, 2 μm or more and 30 μm or less. In view of stably avoiding the anticorrosive property and gloss from significantly deteriorating, it is preferred that each thickness of these coatings is 4 μm or more. Also in view of stably avoiding the occurrence of cracks that negatively affect the anticorrosive property, each thickness of these coatings is preferably 20 μm or less, and more preferably 15 μm or less.

Details of the manufacturing method for the third zinc-containing coating are similar to those for the first zinc-containing coating in the first embodiment, and therefore omitted to be described.

Considering the first zinc-containing coating according to the first embodiment being formed on the substrate, the second zinc-containing coating is different because of being formed on the third zinc-containing coating, but other features are in common with the first embodiment, and hence details of the manufacturing method for the second zinc-containing coating are omitted.

Similar to a structure where the first zinc-containing coating, which constitutes the rust-preventive coating according to the first embodiment, comprises multiple laminated layers, each of the second zinc-containing coating and the third zinc-containing coating according to the present embodiment may comprise multiple laminated layers. In this case, the second zinc-containing coating is preferred to be such that, among characteristics of layers constituting the second zinc-containing coating, at least the mass ratio R2 is substantially in common with one another. In addition, the third zinc-containing coating is preferred to be such that, among characteristics of layers constituting the third zinc-containing coating, at least the mass ratio R3 is substantially in common with one another.

The second zinc-containing coating is formed on the third zinc-containing coating, and therefore, it is preferred that the baking temperature for forming the second zinc-containing coating is equal to or higher than the baking temperature for forming the third zinc-containing coating.

It is also preferred that the second zinc-containing coating, which constitutes the rust-preventive coating according to the present embodiment, is formed on the third zinc-containing coating so as to be in contact therewith.

### (4) Substrate

Types of the substrate to be formed thereon with the rust-preventive coating according to the present embodiment, which comprises the second zinc-containing coating and the third zinc-containing coating, are not particularly limited. Details of specific material and shape of the substrate is the same as those in the first embodiment, and therefore omitted to be described.

### (5) Rust-Preventive Member

The rust-preventive member according to the present embodiment comprises the rust-preventive coating according to the present embodiment on the above substrate, and the rust-preventive coating has the previously-described second zinc-containing coating and the third zinc-containing coating provided on the proximate side of the second zinc-containing coating to the substrate. Comprising this rust-preventive coating allows the rust-preventive member to have an excellent anticorrosive property and high gloss.

In regard to this gloss, it is preferred that a gloss value Gs(60°) at an incident angle of 60° measured in compliance with JIS Z8741 is 7% or more for a surface of the rust-preventive coating. Given such an extent of gloss, the rust-preventive member can be obtained which has favorable appearance from the view point of design without performing a particular appearance adjustment process (typically lamination of colored coating or coatings). In particular, if higher gloss is required, the above gloss value Gs(60°) may be 10% or more, and further preferably 15% or more.

In addition, the rust-preventive member according to the present embodiment may further comprise an overcoat on the above rust-preventive coating. Details thereof are similar to those in the first embodiment, and therefore omitted to be described.

### EXAMPLES

While the present invention will hereinafter be described in more detail with reference to specific experimental results, the scope of the present invention is not to be limited to these experimental results.

### Example 1

### (1) Preparation of Paints

Zinc powder of scale form was prepared as below. Metal zinc powder of 100 parts by weight with an average particle size of 5 μm was dispersed into 200 parts by weight of mineral spirit and a small amount of fatty acid was further added thereto, and shiny was obtained to have a dispersion concentration of the metal zinc powder of about 30 weight %. After being subjected to a crush treatment using a bead mill (Star Mill ZRS available from Ashizawa Finetech Ltd.), the treated slurry was evaporatively dried under reduced pressure, and scale form zinc powder was thus obtained, wherein the center value of longitudinal diameter distribution was 10 μm and the center value of thickness distribution was 0.3 μm.

Five types of scale form aluminum powder (ALPASTE available from Toyo Aluminium K.K.) were also prepared which had different D50 particle sizes and different leafing values defined by JIS K5906, as shown in Table 1.

TABLE 1

| | | | Center value of | |
|---|---|---|---|---|
| | D50 | | distribution of | Center value of |
| Type of | particle | | longitudinal | distribution of |
| aluminum | size (μm) | Leafing value | diameter (μm) | thickness (μm) |
| A | 8 | 70% | 8 | 0.1 |
| B | 5 | 75% | 5 | 0.1 |
| C | 11 | 75% | 11 | 0.1 |
| D | 14 | 75% | 14 | 0.1 |
| E | 17 | 70% | 17 | 0.1 |

Paints No. 1 to No. 12 as nonaqueous paints were produced by stirring components for each paint to mix them according to each composition (parts by mass) shown in Table 2 during three hours using a high-speed stirrer for paints.

TABLE 2

| | | No. 1 | No. 2 | No. 3 | No. 4 | No. 5 | No. 6 | No. 7 | No. 8 | No. 9 | No. 10 | No. 11 | No. 12 |
|---|---|---|---|---|---|---|---|---|---|---|---|---|---|
| Ethyl polysilicate | | 300 | 300 | 300 | 300 | 300 | 300 | 300 | 300 | 300 | 300 | 300 | 300 |
| Tetra-n-butoxy titanium | | 5 | 5 | 5 | 5 | 5 | 5 | 5 | 5 | 5 | 5 | 5 | 5 |
| polymer | | | | | | | | | | | | | |
| Zinc powder | | 380 | 380 | 380 | 380 | 380 | 450 | 405 | 360 | 340 | 315 | 270 | 225 |
| Aluminum powder | A | 70 | | | | | | | | | | | |
| | B | | 70 | | | | | | | | | | |
| | C | | | 70 | | | | | | | | | |
| | D | | | | 70 | | | 45 | 90 | 110 | 135 | 180 | 225 |
| | E | | | | | 70 | | | | | | | |

| | | | | | | | | | | | | |
|---|---|---|---|---|---|---|---|---|---|---|---|---|
| 3-ethoxy ethyl propionate | 80 | 80 | 80 | 80 | 80 | 80 | 80 | 80 | 80 | 80 | 80 | 80 |
| Methyl methoxy butanol | 120 | 120 | 120 | 120 | 120 | 120 | 120 | 120 | 120 | 120 | 120 | 120 |
| Dispersing agent | 30 | 30 | 30 | 30 | 30 | 30 | 30 | 30 | 30 | 30 | 30 | 30 |
| Phenol resin | 5 | 5 | 5 | 5 | 5 | 5 | 5 | 5 | 5 | 5 | 5 | 5 |
| Thickening agent | 10 | 10 | 10 | 10 | 10 | 10 | 10 | 10 | 10 | 10 | 10 | 10 |
| Aluminum powder ratio | 16% | 16% | 16% | 16% | 16% | 0% | 10% | 20% | 24% | 30% | 40% | 50% |
| in metal powder | | | | | | | | | | | | |

Details of components shown in Table 2 were as follows:

ethyl polysilicate: Ethyl Silicate 40 available from COLCOAT CO., LTD.;

tetra-n-butoxy titanium polymer: B-10 available from Nippon Soda Co., Ltd.;

dispersing agent: oxidized polyolefin available from Kusumoto Chemicals, Ltd.;

phenol resin: phenol-formaldehyde resin available from DIC Corporation; and

thickening agent: bentonite available from HOJUN Co.,Ltd.

Note that the “aluminum powder ratio in metal powder” in Table 2 is a ratio (unit: mass %) of the contained amount of the aluminum powder to the total contained amount of the zinc powder and the aluminum powder.

### (2) Preparation of Samples for Appearance Evaluation

After degreasing and washing treatments using known methods in the art, shotblasting treatment (alumina blast) was performed for soft steel plates (SS400).

Obtained steel plates were put into a barrel and the barrel was then immersed into and pulled out from one type of paints No. 1 to No. 5 shown in Table 2, and thereafter the barrel storing the steel plates each deposited thereon with a liquid layer comprised of the paint was rotated to adjust the thickness of the liquid layer on each steel plate. After completing the rotation, the steel plates were taken out from the barrel and subjected to a baking process for heating the steel plates in an oven at 260° C. during 60 minutes. The steel plates after the baking process were taken out from the oven and naturally cooled to room temperature, and samples for appearance evaluation were thus obtained in each of which a rust-preventive coating of 10 μm thickness was formed on the steel plate surface.

### (3) Evaluation

The gloss value Gs(60°) at an incident angle of 60° of each sample for appearance evaluation was measured in compliance with JIS Z8741 using IG-331 available from HORIBA, Ltd.

The measured gloss value Gs(60°) was used for the evaluation of appearance of the sample in accordance with evaluation criteria below. Acceptable (C) or better was evaluated as being successful.

Excellent (A): Gs(60°)≧15%

Favorable (B): 10%≦Gs(60°)<15%

Acceptable (C): 7%≦Gs(60°)<10%

Unacceptable (D): Gs(60°)<7%.

This evaluation will hereinafter be referred to as “appearance evaluation”.

### (4) Evaluation Results

Evaluation results are shown in Table 3.

TABLE 3

| Sample No. | Paint No. | Appearance evaluation |
|---|---|---|
| 1-1 | 1 | D |
| 1-2 | 2 | D |
| 1-3 | 3 | C |
| 1-4 | 4 | B |
| 1-4 | 5 | C |

### Example 2

### (1) Preparation of Samples for Appearance Evaluation

After degreasing and washing treatments using known methods in the art, shotblasting treatment (alumina blast) was performed for soft steel plates (SS400).

Obtained steel plates were put into a barrel and the barrel was then immersed into and pulled out from one type of paints No. 1 to No. 12 shown in Table 2, and thereafter the barrel storing the steel plates each deposited thereon with a liquid layer comprised of the paint was rotated to adjust the thickness of the liquid layer on each steel plate. After completing the rotation, the steel plates were taken out from the barrel and subjected to a baking process for heating the steel plates in an oven at 260° C. during 60 minutes. The steel plates after the baking process were taken out from the oven and naturally cooled to room temperature, and the steel plates were thus obtained each with a coating (lower layer coating) of 5 μm thickness on the surface thereof.

Subsequently, the steel plates each provided thereon with the above lower layer coating were put again into a barrel and the barrel was then immersed into and pulled out from one type of paints No. 1 to No. 12 shown in Table 2, and thereafter, the barrel storing the steel plates where a liquid layer comprised of the paint was deposited on each lower layer coating was rotated to adjust the thickness of the liquid layer on the lower layer coating. After completing the rotation, the steel plates were taken out from the barrel and subjected to a baking process for heating the steel plates in an oven at 260° C. during 60 minutes. The steel plates after the baking process were taken out from the oven and naturally cooled to room temperature, and the steel plates were thus obtained each with a new coating (upper layer coating) of 5 μm thickness on the lower layer coating. In that way, samples for appearance evaluation were obtained in each of which a rust-preventive coating of 10 μm thickness was formed on the steel plate surface.

### (2) Preparation of Samples for Anticorrosive Property Evaluation

After degreasing and washing treatments using known methods in the art, shotblasting treatment (alumina blast) was performed for M10 steel bolts.

Obtained bolts were put into a barrel and the barrel was then immersed into and pulled out from one type of paints No. 1 to No. 12 shown in Table 2, and thereafter the barrel storing the bolts each deposited thereon with a liquid layer comprised of the paint was rotated to adjust the thickness of the liquid layer on each bolt. After completing the rotation, the bolts were taken out from the barrel and subjected to a baking process for heating the bolts in an oven at 260° C. during 60 minutes. The bolts after the baking process were taken out from the oven and naturally cooled to room temperature, and the bolts were thus obtained each with a coating (lower layer coating) of 4 μm thickness on the surface thereof.

Subsequently, the bolts each provided thereon with the above lower layer coating were put again into a barrel and the barrel was then immersed into and pulled out from one type of paints No. 1 to No. 12 shown in Table 2, and thereafter, the barrel storing the bolt where a liquid layer comprised of the paint was deposited on each lower layer coating was rotated to adjust the thickness of the liquid layer on the lower layer coating. After completing the rotation, the bolts were taken out from the barrel and subjected to a baking process for heating the bolts in an oven at 260° C. during 60 minutes. The bolts after the baking process were taken out from the oven and naturally cooled to room temperature, and the bolts were thus obtained each with a new coating (upper layer coating) of 4 μm thickness on the lower layer coating. In that way, samples for anticorrosive property evaluation were obtained in each of which a rust-preventive coating of total 8 μm thickness was formed on the bolt surface.

### (3) Evaluation

In addition to the appearance evaluation, the following evaluation was performed using the samples for anticorrosive property evaluation.

An apparatus in compliance with JIS Z2371 was used to perform neutral salt spray test on the basis of JIS H8502. Samples were visually observed every 24 hours, and the testing time when red rust was recognized first to occur was determined as a red rust occurring time to be used to evaluate the anticorrosive property. If the red rust occurring time was shorter than 1,000 hours, then the anticorrosive property was judged to be poor.

### (4) Evaluation Results

Evaluation results are shown in Table 4. The “R_{L}” used in Table 4 represents a ratio (unit: mass %) of the contained amount of aluminum powder to the total contained amount of zinc powder and aluminum powder in the paint for the lower layer coatings. In addition, the “R_{U}” represents a ratio (unit: mass %) of the contained amount of aluminum powder to the total contained amount of zinc powder and aluminum powder in the paint for the upper layer coatings. Further, the “R_{U}/R_{L}” is a value obtained by dividing the above ratio R_{U} of the contained amount of aluminum powder in the paint for the upper layer coatings by the ratio R_{L} of the contained amount of aluminum powder in the paint for the lower layer coatings, where the ratio R_{L} of 0 mass % is denoted by hyphen (-).

TABLE 4

| | | | | | | | | | Anticorrosive |
|---|---|---|---|---|---|---|---|---|---|
| | Lower layer coating | | | Upper layer coating | | | | | property |
| Sample | Paint | Aluminum | R_{L} | Paint | Aluminum | R_{U} | | Appearance | evaluation |
| No. | No. | powder | (mass %) | No. | powder | (mass %) | R_{U}/R_{L} | evaluation | (hours) |
| 2-1 | 1 | A | 16 | 1 | A | 16 | 1 | D | 2,424 |
| 2-2 | 1 | A | 16 | 2 | B | 16 | 1 | D | 2,424 |
| 2-3 | 1 | A | 16 | 3 | C | 16 | 1 | C | 2,448 |
| 2-4 | 1 | A | 16 | 4 | D | 16 | 1 | B | 2,640 |
| 2-5 | 1 | A | 16 | 5 | E | 16 | 1 | C | 2,640 |
| 2-6 | 1 | A | 16 | 6 | Not | 0 | 0 | D | 1,128 |
| | | | | | containing | | | | |
| 2-7 | 1 | A | 16 | 7 | D | 10 | 0.67 | B | 1,608 |
| 2-8 | 1 | A | 16 | 8 | D | 20 | 1.3 | A | 3,600 |
| 2-9 | 1 | A | 16 | 9 | D | 24 | 1.7 | A | 4,080 |
| 2-10 | 1 | A | 16 | 10 | D | 30 | 2 | A | 4,200 |
| 2-11 | 1 | A | 16 | 11 | D | 40 | 2.7 | A | 3,120 |
| 2-12 | 1 | A | 16 | 12 | D | 50 | 3.3 | A | 1,920 |
| 2-13 | 2 | B | 16 | 1 | A | 16 | 1 | D | 2,424 |
| 2-14 | 3 | C | 16 | 1 | A | 16 | 1 | D | 2,400 |
| 2-15 | 4 | D | 16 | 1 | A | 16 | 1 | D | 2,280 |
| 2-16 | 5 | E | 16 | 1 | A | 16 | 1 | D | 2,160 |
| 2-17 | 6 | Not | 0 | 1 | A | 16 | — | D | 2,328 |
| | | containing | | | | | | | |
| 2-18 | 7 | D | 10 | 1 | A | 16 | 1.5 | D | 2,880 |
| 2-19 | 8 | D | 20 | 1 | A | 16 | 0.75 | D | 2,424 |
| 2-20 | 9 | D | 24 | 1 | A | 16 | 0.6 | D | 2,040 |
| 2-21 | 10 | D | 30 | 1 | A | 16 | 0.5 | D | 1,920 |
| 2-22 | 11 | D | 40 | 1 | A | 16 | 0.38 | D | 1,680 |
| 2-23 | 12 | D | 50 | 1 | A | 16 | 0.3 | D | 1,680 |
| 2-24 | 6 | Not | 0 | 4 | D | 16 | — | B | 2,352 |
| | | containing | | | | | | | |
| 2-25 | 7 | D | 10 | 4 | D | 16 | 1.5 | B | 2,904 |
| 2-26 | 6 | Not | 0 | 12 | D | 50 | — | A | 1,920 |
| | | containing | | | | | | | |
| 2-27 | 12 | D | 50 | 6 | Not | 0 | 0 | D | 960 |
| | | | | | containing | | | | |
| 2-28 | 7 | D | 10 | 11 | D | 40 | 4 | A | 2,640 |
| 2-29 | 11 | D | 40 | 7 | D | 10 | 0.25 | B | 1,128 |
| 2-30 | 8 | D | 20 | 10 | D | 30 | 1.5 | A | 4,080 |
| 2-31 | 10 | D | 30 | 8 | D | 20 | 0.67 | A | 2,400 |
| 2-32 | 1 | A | 16 | 1 | A | 16 | 1 | D | 2,424 |
| 2-33 | 2 | B | 16 | 2 | B | 16 | 1 | D | 2,400 |
| 2-34 | 3 | C | 16 | 3 | C | 16 | 1 | C | 2,448 |
| 2-35 | 4 | D | 16 | 4 | D | 16 | 1 | B | 2,472 |
| 2-36 | 5 | E | 16 | 5 | E | 16 | 1 | C | 2,424 |
| 2-37 | 6 | Not | 0 | 6 | Not | 0 | — | D | 1,128 |
| | | containing | | | containing | | | | |
| 2-38 | 7 | D | 10 | 7 | D | 10 | 1 | B | 1,608 |
| 2-39 | 8 | D | 20 | 8 | D | 20 | 1 | A | 2,280 |
| 2-40 | 9 | D | 24 | 9 | D | 24 | 1 | A | 1,652 |
| 2-41 | 10 | D | 30 | 10 | D | 30 | 1 | A | 1,292 |
| 2-42 | 11 | D | 40 | 11 | D | 40 | 1 | A | 1,104 |
| 2-43 | 12 | D | 50 | 12 | D | 50 | 1 | A | 960 |

1. A rust-preventive coating comprising a first zinc-containing coating obtained by heating a liquid layer, the liquid layer comprising a first zinc-containing inorganic-based paint that contains, on the basis of whole paint, an inorganic binder including 5 mass % or more and 40 mass % or less of an organic silicon compound and 0.05 mass % or more and 2 mass % or less of an organic titanate compound; 20 mass % or more and 60 mass % or less of a first metal-based powder; and 10 mass % or more and 60 mass % or less of an organic solvent, wherein
the first metal-based powder contained in the first zinc-containing inorganic-based paint comprises: a first aluminum-based powder comprising one or more selected from aluminum powders and aluminum alloy powders; and a first zinc-based powder comprising one or more selected from zinc powders and zinc alloy powders, and
the first aluminum-based powder is such that a particle size D50 when a percent passing by weight is 50% in a particle-size accumulation curve is 10 μm or more and 20 μm or less, a leafing value is 70% or more, and a mass ratio to the first metal-based powder is 10 mass % or more and 40 mass % or less.

2. The rust-preventive coating as set forth in claim 1, wherein the first metal-based powder has a scale form.

3. The rust-preventive coating as set forth in claim 2, wherein the metal-based powder having the scale form is such that an average thickness of the metal-based powder is 1/200 or more and ½ or less relative to an average thickness of the first zinc-containing coating that contains the metal-based powder, and an average value of longitudinal diameter of the metal-based powder is 10 times or more and 50 times or less relative to the average thickness of the metal-based powder.

4. The rust-preventive coating as set forth in claim 2, wherein the metal-based powder having the scale form is such that an average value of longitudinal diameter of the metal-based powder is 1.0 μm or more and 50 μm or less, and an average thickness thereof is 0.05 μm or more and 1.0 μm or less.

5. The rust-preventive coating as set forth in either one of claims 1, wherein the organic silicon compound contained in the first zinc-containing inorganic-based paint comprises one or more compounds selected from a group consisting of tetraalkyl silicate compounds having an alkyl group having 3 or less carbon atoms and oligomers thereof.

6. The rust-preventive coating as set forth in either one of claims 1, wherein the organic titanate compound contained in the first zinc-containing inorganic-based paint comprises an organic compound represented by a general formula of Ti(X)₄ and an oligomer thereof, where X represents one or more functional groups selected from a group consisting of: alkoxy groups having 4 or less carbon atoms; chelating substituent groups; and hydroxyl group.

7. A rust-preventive coating comprising a second zinc-containing coating and a third zinc-containing coating provided on a proximate side of the second zinc-containing coating to a substrate, wherein
the second zinc-containing coating is obtained by heating a liquid layer, the liquid layer comprising a second zinc-containing inorganic-based paint that contains, on the basis of whole paint, an inorganic binder including 5 mass % or more and 40 mass % or less of an organic silicon compound and 0.05 mass % or more and 2 mass % or less of an organic titanate compound; 20 mass % or more and 60 mass % or less of a second metal-based powder; and 10 mass % or more and 60 mass % or less of an organic solvent,
the third zinc-containing coating is obtained by heating a liquid layer, the liquid layer comprising a third zinc-containing inorganic-based paint that contains, on the basis of whole paint, an inorganic binder including 5 mass % or more and 40 mass % or less of an organic silicon compound and 0.05 mass % or more and 2 mass % or less of an organic titanate compound; 20 mass % or more and 60 mass % or less of a third metal-based powder; and 10 mass % or more and 60 mass % or less of an organic solvent,
the second metal-based powder contained in the second zinc-containing inorganic-based paint comprises: a second aluminum-based powder comprising one or more selected from aluminum powders and aluminum alloy powders; and a second zinc-based powder comprising one or more selected from zinc powders and zinc alloy powders,
the second aluminum-based powder is such that the a particle size D50 when a percent passing by weight is 50% in a particle-size accumulation curve is 10 μm or more and 20 μm or less, a leafing value is 70% or more, and a mass ratio to the second metal-based powder is 10 mass % or more, and
the third metal-based powder includes a third zinc-based powder comprising one or more selected from zinc powders and zinc alloy powders.

8. The rust-preventive coating as set forth in claim 7, wherein the third metal-based powder further contains a third aluminum-based powder comprising one or more selected from aluminum powders and aluminum alloy powders.

9. The rust-preventive coating as set forth in claim 8, wherein a ratio R2/R3 is larger than one, where R2 represents a mass ratio of the second aluminum-based powder to the second metal-based powder, and R3 represents a mass ratio of the third aluminum-based powder to the third metal-based powder.

10. The rust-preventive coating as set forth in claim 7, wherein at least one of the second metal-based powder and the third metal-based powder has a scale form.

11. The rust-preventive coating as set forth in claim 10, wherein the metal-based powder having the scale form is such that an average thickness of the metal-based powder is 1/200 or more and ½ or less relative to an average thickness of the second zinc-containing coating and/or the third zinc-containing coating that contain the metal-based powder, and an average value of longitudinal diameter of the metal-based powder is 10 times or more and 50 times or less relative to the average thickness of the metal-based powder.

12. The rust-preventive coating as set forth in claim 10, wherein the metal-based powder having the scale form is such that an average value of longitudinal diameter of the metal-based powder is 1.0 μm or more and 50 μm or less, and an average thickness thereof is 0.05 μm or more and 1.0 μm or less.

13. The rust-preventive coating as set forth in claim 7, wherein at least one of the organic silicon compound contained in the second zinc-containing inorganic-based paint and the organic silicon compound contained in the third zinc-containing inorganic-based paint comprises one or more compounds selected from a group consisting of tetraalkyl silicate compounds having an alkyl group having 3 or less carbon atoms and oligomers thereof.

14. The rust-preventive coating as set forth in claim 7, wherein at least one of the organic titanate compound contained in the second zinc-containing inorganic-based paint and the organic titanate compound contained in the third zinc-containing inorganic-based paint comprises an organic compound represented by a general formula of Ti(X)₄ and an oligomer thereof, where X represents one or more functional groups selected from a group consisting of: alkoxy groups having 4 or less carbon atoms; chelating substituent groups; and hydroxyl group.

15. A rust-preventive member comprising the rust preventive coating as set forth in claim 1 on a substrate, wherein a gloss value Gs(60°) at an incident angle of 60° measured in compliance with JIS Z8741 is 7% or more for a surface of the rust-preventive coating.

16. The rust-preventive member as set forth in claim 15, further comprising an overcoat layer provided at outside the rust-preventive coating.
